(19) United States
(12) Patent Application Publication
(10) Pub. No.: US 2026/0158430 A1
(43) Pub. Date: Jun. 11, 2026

(54) NITROGEN GENERATION CONTROL METHOD AND SYSTEM, AND REFRIGERATOR

(71) Applicant: NINGBO FOTILE KITCHEN WARE CO.,LTD., Ningbo (CN)

(72) Inventors: Yanlong MA, Ningbo (CN); Zhixian SHEN, Ningbo (CN)

(21) Appl. No.: 19/433,845

(22) Filed: Dec. 28, 2025

Related U.S. Application Data
(63) Continuation of application No. PCT/CN2025/100500, filed on Jun. 11, 2025.

(30) Foreign Application Priority Data
Jul. 29, 2024 (CN) 202411023141.5

(51) Int. Cl. B01D 53/047; A23B 2/704; A23B 2/708; F25D 17/04

(52) U.S. Cl. CPC B01D 53/047; A23B 2/7045; A23B 2/708; F25D 17/042; B01D 2253/116; B01D 2256/10; B01D 2257/104; B01D 2259/40007

(57) ABSTRACT

A nitrogen generation control method and system, and a refrigerator are provided. The nitrogen generation control method and system are applied to a nitrogen generation device of the refrigerator. The method includes: controlling a molecular sieve tower of the nitrogen generation device to perform exhaust when a refrigerator door is closed for a first preset duration and the refrigerator is in a cooling state, in response to a received nitrogen generation command; and controlling the nitrogen generation device to generate nitrogen after the exhaust of the molecular sieve tower is completed.

### CROSS-REFERENCE TO RELATED APPLICATION

This application is a continuation of international patent application No. PCT/CN 2025/100500, filed on Jun. 11, 2025, which itself claims priority to Chinese patent application No. 202411023141.5, filed on Jul. 29, 2024, and titled “NITROGEN GENERATION CONTROL METHOD AND SYSTEM, AND REFRIGERATOR”. The contents of the above identified applications are hereby incorporated herein in their entireties by reference.

### TECHNICAL FIELD

The present disclosure relates to the technical field of household appliance control, and in particular, to a nitrogen generation control method and system, and a refrigerator.

### BACKGROUND

With the development of household appliance control technology, requirements for household appliances are gradually increasing. Generally, a refrigerator preserves food in the refrigerator by controlling an internal temperature of the refrigerator. However, preserving food in the refrigerator solely by temperature control can cause some food to develop surface wrinkling and scarring, which affects original flavor and nutrition of the food.

Nitrogen, as a colorless and odorless inert gas, is widely used in food preservation. Therefore, by providing a nitrogen generation device in a refrigerator and controlling nitrogen and temperature in the refrigerator, food preservation in the refrigerator can be achieved.

However, a related nitrogen generation control method, in which only various components of the nitrogen generation device are controlled to operate according to preset durations and sequences to achieve periodic or scheduled nitrogen generation, is not suitable for refrigerator environment. If the related nitrogen generation control method is directly applied to a refrigerator for nitrogen generation, a lifespan of the nitrogen generation device may be affected because the nitrogen generation device is not suitable for the refrigerator environment.

For the issue that the lifespan of the nitrogen generation device is affected due to the fact that the related nitrogen generation control method is not suitable for the refrigerator environment, no effective solution is provided at present.

### SUMMARY

According to various embodiments of the present disclosure, a nitrogen generation control method and system, and a refrigerator are provided.

In a first aspect, a nitrogen generation control method is provided in the present disclosure, applied to a nitrogen generation device of a refrigerator. The nitrogen generation control method includes: controlling a molecular sieve tower of the nitrogen generation device to perform exhaust when a refrigerator door is closed for a first preset duration and the refrigerator is in a cooling state, in response to a received nitrogen generation command; and controlling the nitrogen generation device to generate nitrogen after the exhaust of the molecular sieve tower is completed.

In an embodiment, before controlling the molecular sieve tower of the nitrogen generation device to perform exhaust when the refrigerator door is closed for the first preset duration and the refrigerator is in the cooling state, in response to the received nitrogen generation command, the nitrogen generation control method further includes: monitoring an opening time and a closing time of the refrigerator door in real time in response to the received nitrogen generation command; and detecting the cooling state of the refrigeration when the closing time of the refrigerator door reaches the first preset duration.

In an embodiment, controlling the molecular sieve tower of the nitrogen generation device to perform exhaust when the refrigerator door is closed for the first preset duration and the refrigerator is in the cooling state, in response to the received nitrogen generation command, further includes:
controlling a solenoid valve at an oxygen discharge end of the molecular sieve tower of the nitrogen generation device to open when the refrigerator door is closed for the first preset duration and the refrigerator is in the cooling state, in response to the received nitrogen generation command; and
controlling the solenoid valve at the oxygen discharge end of the molecular sieve tower to close after the solenoid valve at the oxygen discharge end of the molecular sieve tower is opened for a second preset duration.

In an embodiment, the nitrogen generation control method further includes: controlling the molecular sieve tower of the nitrogen generation device to perform exhaust when a closing time of the refrigerator door reaches a third preset duration, in response to a received initial nitrogen generation command; and controlling the nitrogen generation device to generate nitrogen after the exhaust of the molecular sieve tower is completed.

In an embodiment, controlling the nitrogen generation device to generate nitrogen after the exhaust of the molecular sieve tower is completed further includes: after the exhaust of the molecular sieve tower is completed, when the refrigerator door is opened after the nitrogen generation device is controlled to generate nitrogen for a fourth duration, controlling the nitrogen generation device to stop generating nitrogen. The fourth duration is less than a preset nitrogen generating duration.

In an embodiment, after the exhaust of the molecular sieve tower is completed, when the refrigerator door is opened after the nitrogen generation device is controlled to generate nitrogen for a fourth duration, controlling the nitrogen generation device to stop generating nitrogen, the nitrogen generation control method further includes: controlling the molecular sieve tower of the nitrogen generation device to perform exhaust when a closing time of the refrigerator door reaches the first preset duration and the refrigerator is in the cooling state; and controlling the nitrogen generation device to generate nitrogen until a fifth preset duration is reached after the exhaust of the molecular sieve tower is completed. The fifth preset duration is equal to a time difference between the preset nitrogen generating duration and the fourth duration.

In an embodiment, after controlling the nitrogen generation device to generate nitrogen after the exhaust of the molecular sieve tower is completed, the nitrogen generation control method further includes: generating nitrogen for the refrigerator periodically at a preset time interval when the refrigerator door remains closed.

In an embodiment, after controlling the nitrogen generation device to generate nitrogen after the exhaust of the molecular sieve tower is completed, the nitrogen generation control method further includes: controlling the molecular sieve tower of the nitrogen generation device to perform exhaust, when the refrigerator door is closed for the preset first duration after being opened and the refrigerator is in the cooling state; and controlling the nitrogen generation device to generate nitrogen until a preset nitrogen generating duration is reached, after the exhaust of the molecular sieve tower is completed.

In an embodiment, controlling the molecular sieve tower of the nitrogen generation device to perform exhaust, when the refrigerator door is closed for the preset first duration after being opened and the refrigerator is in the cooling state, further includes: controlling the molecular sieve tower of the nitrogen generation device to perform exhaust, after the refrigerator door is closed for the first preset duration after being opened and the refrigerator maintains continues cooling for a sixth preset duration.

In a second aspect, a nitrogen generation control system, applied to a nitrogen generation device of a refrigerator, is provided in the present disclosure. The nitrogen generation control system includes an exhaust module and a nitrogen generation module.

The exhaust module is configured to control a molecular sieve tower of the nitrogen generation device to perform exhaust when a refrigerator door is closed for a first preset duration and the refrigerator is in a cooling state, in response to a received nitrogen generation command.

The nitrogen generation module is configured to control the nitrogen generation device to generate nitrogen after the exhaust of the molecular sieve tower is completed.

In a third aspect, a refrigerator is provided in the present disclosure. The refrigerator includes a cooling device, a nitrogen generation device, and a processor and a memory connected to the cooling device and the nitrogen generation device.

The cooling device is configured to cool the refrigerator when the refrigerator is in a cooling state.

The nitrogen generation device is configured to generate nitrogen for the refrigerator.

The nitrogen generation device at least includes a molecular sieve tower, an air pump and a solenoid valve. The molecular sieve tower, filled with a nitrogen generation molecular sieve inside, is configured to convert received air into nitrogen and oxygen to generate nitrogen for the refrigerator. The air pump is configured to fill air into the molecular sieve tower. The solenoid valve is located at an oxygen discharge end of the molecular sieve tower.

The memory is configured to store a computer program. The processor, when executing the computer program, implements steps of the nitrogen generation control method described in the first aspect.

The details of one or more embodiments of the present disclosure are set forth in the accompanying drawings and description below, to make other features, purposes, and advantages of the present disclosure clearer and easier to comprehend.

### BRIEF DESCRIPTION OF THE DRAWINGS

In order to more clearly illustrate the technical solutions in the embodiments of the present disclosure, the accompanying drawings that need to be used in the description of the embodiments will be briefly introduced below. It is obvious that the accompanying drawings in the following description are only some embodiments of the present disclosure, and those skilled in the art can obtain other drawings according to the disclosed drawings without creative efforts.

FIG. 1 is a hardware structural block diagram of a terminal for implementing a nitrogen generation control method according to an embodiment of the present disclosure.

FIG. 2 is a flowchart of a nitrogen generation control method according to an embodiment of the present disclosure.

FIG. 3 is a flowchart of a nitrogen generation control method according to an alternative embodiment of the present disclosure.

FIG. 4 is a structural block diagram of a nitrogen generation control system according to an embodiment of the present disclosure.

FIG. 5 is a structural block diagram of a refrigerator according to an embodiment of the present disclosure.

### DETAILED DESCRIPTION

To more clearly understand the objectives, technical solutions, and advantages of the present disclosure, the present disclosure will be described and illustrated below with reference to the accompanying drawings and embodiments.

Unless otherwise defined, technical or scientific terms used in the present disclosure should have general meanings understood by those skilled in the art to which the present disclosure belongs. The terms “a”, “an”, “one”, “the”, “these”, and the like in the present disclosure do not denote a limitation of quantity, and may be singular or plural. The terms “comprise”, “include”, “have”, and any variations thereof, as used herein, are intended to cover non-exclusive inclusion. For example, a process, a method and system, a product, or a device that includes a series of steps or modules (units) is not limited to the listed steps or modules (units), but may include steps or modules (units) not listed, or may include other steps or modules (units) inherent to such process, method, product, or device. Terms such as “connected to”, “linked to” and “coupled to” referred to in the present disclosure are not limited to physical or mechanical connections, but may include electrical connections, whether direct connections or indirect connections. The term “a plurality of” as used herein means two or more. The term “and/or” describes an association relationship between associated objects, indicating that there may be three relationships. For example, “A and/or B” may indicate that the following three cases: only A exists, both A and B exist, and only B exists. Generally, the character “/” indicates an “or” relationship between the associated objects preceding and following the character “/”. The terms such as “first”, “second”, and “third” referred to in the present disclosure are merely intended to distinguish between similar objects and do not imply a specific ordering of the objects.

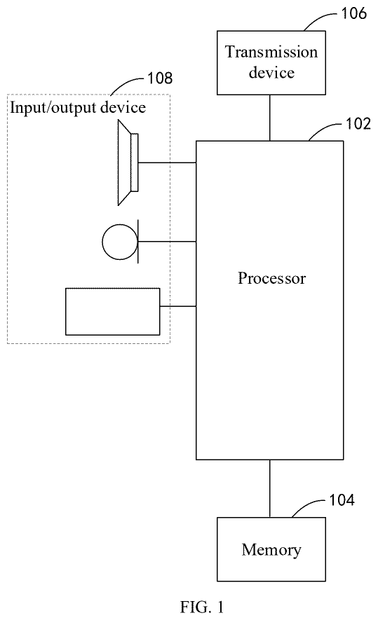

In the present embodiment, the method provided may be executed on a terminal, a computer, or a similar computing device. For example, the method may be executed on a terminal. FIG. 1 is a hardware structural block diagram of a terminal for implementing the nitrogen generation control method according to the present embodiment. Referring to FIG. 1, the terminal may include one or more processors 102 (only one is shown in FIG. 1) and a memory 104 for data storage. The processor 102 may include, but not be limited to, a processing device such as a microprocessor unit MCU or a field-programmable gate array FPGA. The terminal may further include a transmission device 106 and an input/output device 108 that are configured for communication functions. Those skilled in the art may understand that the structure shown in FIG. 1 is merely illustrative and does not limit the structure of the terminal. For example, the terminal may further include more or fewer components than those shown in FIG. 1 or may have a different configuration from that shown in FIG. 1.

The memory 104 may be configured to store a computer program, such as a software program and a module of application software, including a computer program corresponding to the nitrogen generation control method in the present embodiment. By executing the computer program stored in the memory 104, the processor 102 performs various functional applications and data processing, thereby implementing the above method. The memory 104 may include a high-speed random access memory, and may further include a non-volatile memory, such as one or more magnetic storage devices, flash memory, or other non-volatile solid-state memory. In some examples, the memory 104 may further include a memory remotely disposed relative to the processor 102. The remote memory may be connected to the terminal via a network. Examples of the above network may include, but not be limited to, the Internet, an intranet, a local area network, a mobile communication network, and combinations thereof.

The transmission device 106 may be configured to receive or transmit data via a network. The network may include a wireless network provided by a communication provider of the terminal. In an example, the transmission device 106 may include a network interface controller (NIC), which may be connected to other network devices via a base station to communicate with the Internet. In an example, the transmission device 106 may be a radio frequency (RF) module configured to communicate wirelessly with the Internet.

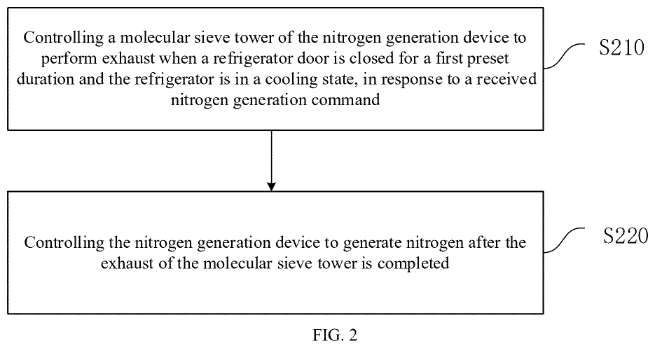

A nitrogen generation control method is provided in the present disclosure. FIG. 2 is a flowchart of the nitrogen generation control method according to the present embodiment. Referring to FIG. 2, the method includes the following step 210 and step 210.

Step 210 includes controlling a molecular sieve tower of the nitrogen generation device to perform exhaust when a refrigerator door is closed for a first preset duration and the refrigerator is in a cooling state, in response to a received nitrogen generation command.

The nitrogen generation command may be a command sent by a user to activate the nitrogen generation function. In the intelligent control of the refrigerator, the user may select to turn the nitrogen generation function on and off as required, thereby enabling or disabling an oxygen-controlled preservation function of a preservation compartment of the refrigerator. Specifically, a command for turning the nitrogen generation function on and off may be sent to a main control terminal of the refrigerator by a user through means such as an operation panel of the refrigerator or a mobile application (APP). The preservation compartment may be an oxygen-controlled preservation space inside the refrigerator used for storing food. It should be noted that the preservation compartment has good tightness. When the refrigerator door is closed, the preservation compartment performs slow air exchange with the external environment, or even undergoes no air exchange, to maintain a low-oxygen environment inside the preservation compartment, thereby achieving food preservation. When the refrigerator door is opened, the air inside the preservation compartment is quickly exchanged with the air in the external environment of the refrigerator, causing the air inside the preservation compartment to return to a normal nitrogen-oxygen state.

The opening and closing of the refrigerator door predominantly occur during daily meal preparation periods, especially meal preparation time periods around noon or in the evening. During these periods, the need to prepare various ingredients may lead to frequent opening and closing of the refrigerator door within a short period. If nitrogen generation is initiated immediately after the refrigerator door is closed, the nitrogen generation process may be repeatedly interrupted due to the frequent opening and closing of the refrigerator door in a short time. This may result in the nitrogen generation device being activated multiple times in a short time, affecting a lifespan of the nitrogen generation device. To avoid such frequent activations of the nitrogen generation device, the opening time and the closing time of the refrigerator door are monitored in the present embodiment. Thus, it may be ensured that the nitrogen generation by the nitrogen generation device is initiated after the refrigerator door is closed for the first preset duration. The first preset duration may be specifically set according to actual requirements. For example, the first preset duration may be set to 30 minutes, or the first preset duration may be set to 10 minutes.

The nitrogen generation device may be configured to generate nitrogen by using pressure swing adsorption (PSA) method. In a specific nitrogen generation process, when air enters the molecular sieve tower of the nitrogen generation device, a molecular sieve inside the molecular sieve tower may preferentially intercept oxygen and subsequently release nitrogen, thereby achieving nitrogen generation. In this process, the molecular sieve in the molecular sieve tower may also have the characteristic of preferentially adsorbing moisture from the air. However, when the molecular sieve adsorbs excessive moisture, the moisture may damage microscopic micropores adsorbing oxygen on a surface of the molecular sieve. This impairs the ability of the molecular sieve to effectively separate nitrogen and oxygen from the air, resulting in a reduction in the nitrogen generation capability of the molecular sieve. Therefore, before the air is filled into the molecular sieve tower of the nitrogen generation device, it is essential to ensure that the humidity of the filled air reaches a preset humidity requirement. Specifically, the humidity of the air filled into the molecular sieve tower of the nitrogen generation device needs to be lower than a humidity threshold. The humidity threshold is a minimum humidity level affecting the nitrogen generation capability of the nitrogen generation device.

Generally, air from inside or outside the refrigerator may be used as the raw material for nitrogen generation by the nitrogen generation device. When air from outside the refrigerator is used as the raw material for nitrogen generation by the nitrogen generation device, since the humidity of the air outside the refrigerator is generally greater than the humidity threshold, it is necessary to dehumidify the air outside the refrigerator, and the dehumidified air is filled into the molecular sieve tower of the nitrogen generation device for nitrogen generation. However, this approach requires providing a dehumidification device inside or outside the refrigerator, which increases cost and is not conducive to the integration of the nitrogen generation device. When air from inside the refrigerator is used as the raw material for nitrogen generation by the nitrogen generation device, the humidity inside the refrigerator is generally greater than the humidity threshold. However, when the refrigerator is in the cooling state, the air humidity inside the refrigerator may decrease significantly. At this time, the humidity in the refrigerator may decrease to less than the humidity threshold. On this basis, when the refrigerator is in the cooling state, the nitrogen generation device may be controlled to generate nitrogen in the present embodiment. This eliminates the need for further dehumidification of the air inside the refrigerator, allowing the air inside the refrigerator to be directly used as the raw material for nitrogen generation. This approach is simple, cost-effective, and avoids the issue of reduced lifespan of the nitrogen generation device caused by excessive humidity of the air filled in the molecular sieve tower of the nitrogen generation device.

Step 220 includes controlling the nitrogen generation device to generate nitrogen after the exhaust of the molecular sieve tower is completed.

It should be noted that before the nitrogen generation device is controlled to generate nitrogen, the molecular sieve tower of the nitrogen generation device may be in a high-pressure state due to a previous nitrogen generation. In this case, an air pump of the nitrogen generation device is subjected to a load caused by high pressure. If the nitrogen generation device is directly controlled to generate nitrogen, the air pump may be damaged from starting under the load. On this basis, before controlling the nitrogen generation device to generate nitrogen, it is necessary to control the molecular sieve tower of the nitrogen generation device to perform exhaust. This ensures that the nitrogen generation device to generate nitrogen under the condition that both the molecular sieve tower and the air pump are returned to a normal atmospheric state, thereby avoiding the issue that the lifespan of the nitrogen generation device is affected by the starting under pressure of the air pump of the nitrogen generation device.

Furthermore, controlling the nitrogen generation device to generate nitrogen may involve controlling the nitrogen generation device to generate nitrogen for a preset nitrogen generating duration and then stopping. The preset nitrogen generation duration may be set according to a specific scenario, as long as it can be ensured that after the nitrogen generation by the nitrogen generation device reaches the preset nitrogen generating duration, a nitrogen concentration in a preservation compartment of the refrigerator reaches a preset level, or an oxygen concentration in the preservation compartment in the refrigerator is reduced to a preset level. It should be noted that due to structural constraints of the refrigerator, the nitrogen generation device provided on the refrigerator is generally compact and low in complexity, resulting in limited nitrogen generation capability. On this basis, the preset nitrogen generating duration can be calculated according to the size of the preservation compartment of the refrigerator and the nitrogen generation efficiency of the nitrogen generation device.

In the above step 210 and step 220, the molecular sieve tower of the nitrogen generation device is controlled to perform exhaust when the refrigerator door is closed for the first preset duration and the refrigerator is in the cooling state, in response to the received nitrogen generation command, and the nitrogen generation device is controlled to generate nitrogen after the exhaust of the molecular sieve tower is completed. By generating nitrogen while the refrigerator is in the cooling state, during which the air humidity inside the refrigerator is reduced in the cooling state of the refrigerator, the air humidity obtained by the molecular sieve tower of the nitrogen generation device is relatively low. This resolves the issue that the lifespan of the nitrogen generation device is affected due to the fact that the air humidity obtained by the molecular sieve tower is relatively high in the refrigerator. In addition, by performing exhaust of the molecular sieve tower before initiating nitrogen generation, pressurized starting of the air pump of the nitrogen generation device is avoided, enabling the nitrogen generation device to be compatible with the environment of the refrigerator. This addresses the issue that the lifespan of the nitrogen generation device is affected due to the fact that the related nitrogen generation control method is not suitable for the refrigerator environment for nitrogen generation of the refrigerator.

In addition, in an embodiment, before step 210, the method may further include the following step 202 and step 204.

Step 202 may include monitoring an opening time and a closing time of the refrigerator door in real time in response to the received nitrogen generation command.

The opening time may refer to a duration for which the refrigerator door remains continuously open. The closing time may refer to a duration for which the refrigerator door remains continuously closed. This step may involve real-time monitoring of the opening time and the closing time of the refrigerator door, so that the cooling state of the refrigerator is detected when the closing time of the refrigerator reaches the first preset duration. In addition, by detecting the opening time and the closing time of the refrigerator door, time intervals in which the user frequently opens and closes the refrigerator door and pattern of the time intervals between openings and closings of the refrigerator door may be determined according to the detected data. This may facilitate setting an activation time and a deactivation time of the nitrogen generation function based on the time intervals in which the user frequently opens and closes the refrigerator door, as well as setting a more reasonable first duration based on the pattern of the time intervals between openings and closings of the refrigerator door.

Step 204 may include detecting the cooling state of the refrigeration when the closing time of the refrigerator door reaches the first preset duration.

The cooling state of the refrigerator may include two scenarios: the refrigerator is in the cooling state and the refrigerator is not in the cooling state. The refrigerator is in the cooling state when a cooling device of the refrigerator performs cooling for the refrigerator, and the refrigerator is not in the cooling state when the cooling device does not perform cooling for the refrigerator.

According to the above step 202 and step 204, the opening time and the closing time of the refrigerator door may be monitored in real time in response to the received nitrogen generation command, enabling the monitoring of the cooling state of the refrigerator when the closing time of the refrigerator door reaches the first preset duration. By monitoring the cooling state of the refrigerator when the closing time of the refrigerator door reaches the first preset duration, timely control of the nitrogen generation device for nitrogen generation is ensured under the conditions that the refrigerator door is closed for the first preset duration and the refrigerator is in the cooling state. By utilizing the air inside the refrigerator for nitrogen generation when the refrigerator is in the cooling state, it may be ensured that the humidity of the air filled into the nitrogen generation device does not affect the lifespan of the nitrogen generation device, thereby enabling the nitrogen generation device to be compatible with the refrigerator environment. The issue that the lifespan of the nitrogen generation device is affected due to the fact that the related nitrogen generation control method is not suitable for the refrigerator environment for nitrogen generation of the refrigerator may be solved.

Furthermore, in an embodiment, the above step 210 of controlling the molecular sieve tower of the nitrogen generation device to perform exhaust when the refrigerator door is closed for the first preset duration and the refrigerator is in the cooling state, in response to the received nitrogen generation command, may include the following step 212 and step 214.

Step 212 may include controlling a solenoid valve at an oxygen discharge end of the molecular sieve tower of the nitrogen generation device to open when the refrigerator door is closed for the first preset duration and the refrigerator is in the cooling state, in response to the received nitrogen generation command.

When the solenoid valve at the oxygen discharge end of the molecular sieve tower of the nitrogen generation device is opened, the molecular sieve tower of the nitrogen generation device may be in communication with the external environment through the solenoid valve. When the molecular sieve tower is in a high-pressure state, the oxygen adsorbed by the molecular sieve in the molecular sieve tower may be released and discharged outside the molecular sieve tower via the solenoid valve. In the process, the internal pressure of the molecular sieve tower may be reduced to be equal to the atmospheric pressure outside the molecular sieve tower.

Step 214 may include controlling the solenoid valve at the oxygen discharge end of the molecular sieve tower to close after the solenoid valve at the oxygen discharge end of the molecular sieve tower is opened for a second preset duration.

The second preset duration may be specifically set according to specific requirements, as long as it ensures that the internal pressure of the molecular sieve tower can be reduced to be equal to the atmospheric pressure outside the molecular sieve tower within the second preset duration. For example, the second preset duration may be set to 10 seconds.

Step 212 and step 214 described above involving controlling the solenoid valve at the oxygen discharge end of the molecular sieve tower of the nitrogen generation device to open when the refrigerator door is closed for the first preset duration and the refrigerator is in the cooling state, in response to the received nitrogen generation command, and controlling the solenoid valve at the oxygen discharge end of the molecular sieve tower to close after the solenoid valve at the oxygen discharge end of the molecular sieve tower is opened for the second preset duration. In this way, the high-pressure state of the molecular sieve tower may be reduced to the normal atmospheric pressure, ensuring that the molecular sieve tower of the nitrogen generation device is controlled to perform exhaust before the nitrogen generation device is controlled to generate nitrogen. This may ensure the nitrogen generation device begins nitrogen generation under the condition that both the molecular sieve tower and the air pump are returned to the normal atmospheric pressure, thereby preventing the issue that the lifespan of the nitrogen generation device is affected by the starting under pressure of the air pump of the nitrogen generation device.

In an embodiment, the nitrogen generation control method may further include the following step 230 and step 240.

Step 230 may include controlling the molecular sieve tower of the nitrogen generation device to perform exhaust when a closing time of the refrigerator door reaches a third preset duration, in response to a received initial nitrogen generation command.

When an initial nitrogen generation command is received, nitrogen generation for the refrigerator may need to be performed within a short period. Accordingly, the third preset duration may be set specifically as required, and may be a relatively short duration. Generally, the third preset duration may be less than the first preset duration. For example, the third preset duration may be 15 seconds.

Step 240 may include controlling the nitrogen generation device to generate nitrogen after the exhaust of the molecular sieve tower is completed.

In the above step S230 to step S240, the nitrogen generation device may be controlled to generate nitrogen when the closing time of the refrigerator door reaches the third preset duration, in response to the received initial nitrogen generation command. Thus, rapid nitrogen generation within the short period after receiving the initial nitrogen generation command can be ensured.

Alternatively, the molecular sieve tower of the nitrogen generation device may be controlled to perform exhaust when the closing time of the refrigerator door reaches the third preset duration and the refrigerator is in the cooling state, in response to the received initial nitrogen generation command. After the exhaust of the molecular sieve tower is completed, the nitrogen generation device may be controlled to generate nitrogen.

Specifically, in an embodiment, step 220 of controlling the nitrogen generation device to generate nitrogen after the exhaust of the molecular sieve tower is completed includes the following step 222.

Step 222 may include after the exhaust of the molecular sieve tower is completed, when the refrigerator door is opened after the nitrogen generation device is controlled to generate nitrogen for a fourth duration, controlling the nitrogen generation device to stop generating nitrogen. The fourth duration may be less than a preset nitrogen generating duration.

After the nitrogen generation device is controlled to generate nitrogen for the fourth duration, when the refrigerator door is opened, the oxygen-controlled preservation space inside the refrigerator is exposed. At this time, the preservation compartment of the refrigerator cannot maintain a low-oxygen state. Continuing nitrogen generation of the nitrogen generation device while the refrigerator door is open would be meaningless. Furthermore, if the nitrogen generation continues when the refrigerator door is opened, certain noise may be generated, affecting user experience. On this basis, when the refrigerator door is opened, the nitrogen generation device may need to be controlled to stop generating nitrogen. By controlling the nitrogen generation device to stop nitrogen generation when the refrigerator door is opened in the nitrogen generation process, the nitrogen generation may be timely stopped under the condition that the nitrogen generation process is interrupted, and invalid nitrogen generation that may affect the lifespan of the nitrogen generation device may be avoided.

Furthermore, in an embodiment, after step 222, the nitrogen generation control method may further include step 224 and step 226.

Step 224 may include controlling the molecular sieve tower of the nitrogen generation device to perform exhaust when a closing time of the refrigerator door reaches the first preset duration and the refrigerator is in the cooling state.

Step 226 may include controlling the nitrogen generation device to generate nitrogen until a fifth preset duration is reached after the exhaust of the molecular sieve tower is completed, and the fifth preset duration is equal to a time difference between the preset nitrogen generating duration and the fourth duration.

In the above step 224 and step 226, after the nitrogen generation process is interrupted due to the opening of the refrigerator door, the nitrogen generation device may be controlled to generate nitrogen and continue until the fifth preset duration is reached and then stopped when it is detected that the closing time of the refrigerator door reaches the first preset duration and the refrigerator is in the cooling state. This may ensure that the total duration of nitrogen generation before and after the nitrogen generation process is interrupted is equal to the preset nitrogen generating duration. Thus, this solution may avoid the situation that each time the refrigerator door is closed, nitrogen generation continues for the preset nitrogen generating duration, which leads to excessive consumption of the molecular sieve in the nitrogen generation device.

Furthermore, in an embodiment, after the step 220, the nitrogen generation control method may further include the following step 250.

Step 250 may include generating nitrogen for the refrigerator periodically at a preset time interval when the refrigerator door remains closed.

The preset time interval may be specifically set according to an actual condition. For example, the preset time interval may be 8 hours. The periodic nitrogen generation for the refrigerator may involve periodically performing the following process: detecting the cooling state of the refrigerator; when the refrigerator is in the cooling state, controlling the molecular sieve tower of the nitrogen generation device to perform exhaust and controlling the nitrogen generation device to generate nitrogen after the exhaust of the molecular sieve tower is completed; and when the refrigerator is not in the cooling state, performing continuous detection until the refrigerator enters the cooling state, controlling the molecular sieve tower of the nitrogen generation device to perform exhaust after the refrigerator is continuously cooling for a sixth preset duration, and controlling the nitrogen generation device to generate nitrogen after the exhaust of the molecular sieve tower is completed. Specifically, the process may involve periodically performing the following steps: detecting the cooling state of the refrigerator; when the refrigerator is in the cooling state, controlling the solenoid valve at the oxygen discharge end of the molecular sieve tower of the nitrogen generation device to open; after the solenoid valve at the oxygen discharge end of the molecular sieve tower is opened for the second preset duration, controlling the solenoid valve at the oxygen discharge end of the molecular sieve tower to close; and after the solenoid valve at the oxygen discharge end of the molecular sieve tower is closed, controlling the nitrogen generation device to generate nitrogen until the preset nitrogen generating duration is reached and then stop. Alternatively, the process may involve periodically performing the following steps: when the refrigerator is not in the cooling state, performing continuous detection until the refrigerator enters the cooling state; controlling the solenoid valve at the oxygen discharge end of the molecular sieve tower to open when the refrigerator is continuously cooling for the sixth preset duration; after the solenoid valve at the oxygen discharge end of the molecular sieve tower is opened for the second preset duration, controlling the solenoid valve at the oxygen discharge end of the molecular sieve tower to close; and after the solenoid valve at the oxygen discharge end of the molecular sieve tower is closed, controlling the nitrogen generation device to generate nitrogen until the preset nitrogen generating duration is reached and then stop. The sixth preset duration may be specifically set as required. For example, the sixth preset duration may be set to 5 minutes, as long as it ensures that the air humidity inside the refrigerator is less than the humidity threshold after the refrigerator is continuously cooling for the sixth preset duration.

Through this step, nitrogen can be generated for the refrigerator periodically at the preset time interval when the refrigerator door remains closed, and thus periodic nitrogen replenishment inside the refrigerator at the preset time interval can be achieved. It may be ensured that the preservation compartment of the refrigerator remains in a continuous low-oxygen preservation state. This may enable sustained preservation of food inside the refrigerator.

In addition, in an embodiment, after the step 220, the nitrogen generation control method may further include the following step 260 and step 270.

Step 260 may include controlling the molecular sieve tower of the nitrogen generation device to perform exhaust, when the refrigerator door is closed for the preset first duration after being opened and the refrigerator is in the cooling state.

Step S270 may include controlling the nitrogen generation device to generate nitrogen until a preset nitrogen generating duration is reached, after the exhaust of the molecular sieve tower is completed.

In the step 260 and step 270, the nitrogen generation device may be controlled to generate nitrogen until the preset duration is reached when the refrigerator door is closed for the preset first duration after being opened and the refrigerator is in the cooling state, thereby achieving the nitrogen generation control for scenarios where the refrigerator door is closed after being opened.

Specifically, in an embodiment, the above step 260 of controlling the molecular sieve tower of the nitrogen generation device to perform exhaust, when the refrigerator door is closed for the preset first duration after being opened and the refrigerator is in the cooling state, may further include the following step 262.

Step 262 may include controlling the molecular sieve tower of the nitrogen generation device to perform exhaust, after the refrigerator door is closed for the first preset duration after being opened and the refrigerator maintains continues cooling for a sixth preset duration.

Through this step, nitrogen generation by the nitrogen generation device may be initiated after the refrigerator door is closed for the first preset duration following an opening event and the refrigerator is continuously cooling for the preset duration. It may be ensured that nitrogen generation occurs under conditions where the air humidity inside the refrigerator is below the humidity threshold. In this way, the lifespan of the nitrogen generation device may not be affected by the humidity of the air filled into the nitrogen generation device, so that the nitrogen generation device can be in compatible with the refrigerator environment. Thus, the issue that the lifespan of the nitrogen generation device is affected due to the fact that the related nitrogen generation control method is not suitable for the refrigerator environment for nitrogen generation of the refrigerator may be solved.

The present embodiment will be further described and illustrated by an alternative embodiment.

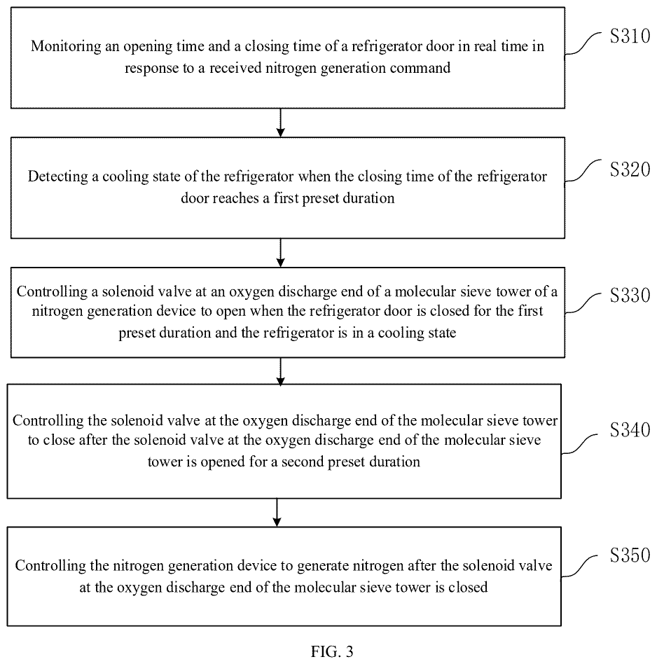

FIG. 3 is a flowchart of a nitrogen generation control method according to an alternative embodiment of the present disclosure. Referring to FIG. 3, the nitrogen generation control method includes the following step 310 to step 350.

Step 310 may include monitoring an opening time and a closing time of a refrigerator door in real time in response to a received nitrogen generation command;

Step 320 may include detecting a cooling state of the refrigerator when the closing time of the refrigerator door reaches a first preset duration;

Step 330 may include controlling a solenoid valve at an oxygen discharge end of a molecular sieve tower of a nitrogen generation device to open when the refrigerator door is closed for the first preset duration and the refrigerator is in a cooling state;

Step 340 may include controlling the solenoid valve at the oxygen discharge end of the molecular sieve tower to close after the solenoid valve at the oxygen discharge end of the molecular sieve tower is opened for a second preset duration;

Step 350 may include controlling the nitrogen generation device to generate nitrogen after the solenoid valve at the oxygen discharge end of the molecular sieve tower is closed.

In the above step 310 to step 350, the molecular sieve tower of the nitrogen generation device is controlled to perform exhaust when the refrigerator door is closed for the first preset duration and the refrigerator is in the cooling state, in response to the received nitrogen generation command, and the nitrogen generation device is controlled to generate nitrogen after the exhaust of the molecular sieve tower is completed. By generating nitrogen while the refrigerator is in the cooling state, during which the air humidity inside the refrigerator is reduced in the cooling state of the refrigerator, the air humidity obtained by the molecular sieve tower of the nitrogen generation device is relatively low. This resolves the issue that the lifespan of the nitrogen generation device is affected due to the fact that the air humidity obtained by the molecular sieve tower is relatively high in the refrigerator. In addition, by performing exhaust of the molecular sieve tower before initiating nitrogen generation, pressurized starting of the air pump of the nitrogen generation device is avoided, enabling the nitrogen generation device to be compatible with the environment of the refrigerator. This addresses the issue that the lifespan of the nitrogen generation device is affected due to the fact that the related nitrogen generation control method is not suitable for the refrigerator environment for nitrogen generation of the refrigerator.

It should be understood that although various steps in the flowchart are displayed in sequence as indicated by the arrows, these steps are not necessarily performed in sequence in the order indicated by the arrows. Unless expressly stated herein, the execution of these steps is not strictly limited in sequence, and these steps may be performed in other orders. Moreover, at least a part of the steps in the flowcharts related to the embodiments described above may include a plurality of steps or a plurality of stages, which are not necessarily performed at the same time, but may be executed at different times. The execution order of these sub-steps or stages is also not necessarily sequential, but may be performed alternately or interleaved with other steps or at least a part of the steps or stages of other steps.

Based on the same inventive concept, the present embodiment further provides a nitrogen generation control system. The system is configured to implement the above embodiments and alternative implementations. Descriptions already provided will not be repeated. Terms such as “module”, “unit”, and “sub-unit” used in the following may refer to combinations of software and/or hardware capable of achieving predetermined functions. Although the system described in the following embodiments may be implemented in software, implementation via hardware, or a combination of software and hardware, is also possible and conceivable.

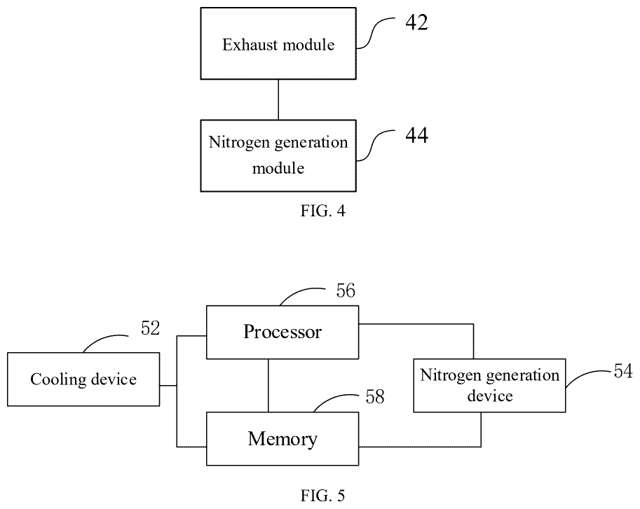

In an embodiment, FIG. 4 is a structural block diagram of a nitrogen generation control system according to an embodiment of the present disclosure. Referring to FIG. 4, the nitrogen generation control system includes an exhaust module 42 and a nitrogen generation module 44.

The exhaust module 42 is configured to control a molecular sieve tower of the nitrogen generation device to perform exhaust when a refrigerator door is closed for a first preset duration and the refrigerator is in a cooling state, in response to a received nitrogen generation command.

The nitrogen generation module 44 is configured to control the nitrogen generation device to generate nitrogen after the exhaust of the molecular sieve tower is completed.

According to the nitrogen generation control system, the molecular sieve tower of the nitrogen generation device is controlled to perform exhaust when the refrigerator door is closed for the first preset duration and the refrigerator is in the cooling state, in response to the received nitrogen generation command, and the nitrogen generation device is controlled to generate nitrogen after the exhaust of the molecular sieve tower is completed. By generating nitrogen while the refrigerator is in the cooling state, during which the air humidity inside the refrigerator is reduced in the cooling state of the refrigerator, the air humidity obtained by the molecular sieve tower of the nitrogen generation device is relatively low. This resolves the issue that the lifespan of the nitrogen generation device is affected due to the fact that the air humidity obtained by the molecular sieve tower is relatively high in the refrigerator. In addition, by performing exhaust of the molecular sieve tower before initiating nitrogen generation, pressurized starting of the air pump of the nitrogen generation device is avoided, enabling the nitrogen generation device to be compatible with the environment of the refrigerator. This addresses the problem that the lifespan of the nitrogen generation device is affected due to the fact that the related nitrogen generation control method is not suitable for the refrigerator environment for nitrogen generation of the refrigerator.

It should be noted that the above modules may be functional modules or program modules, and may be implemented by software or hardware. For modules implemented by the hardware, all of the modules above may be arranged in the same processor, or the modules may be separately arranged in different processors in a manner of any combination.

In an embodiment, a refrigerator is provided, FIG. 5 is a structural block diagram of a refrigerator according to an embodiment of the present disclosure. Referring to FIG. 5, the refrigerator includes a cooling device 52, a nitrogen generation device 54, and a processor 56 and a memory 58 connected to the cooling device 52 and the nitrogen generation device 54.

The cooling device 52 is configured to cool the refrigerator when the refrigerator is in a cooling state;

The nitrogen generation device 54 is configured to generate nitrogen for the refrigerator;

The nitrogen generation device 54 at least includes a molecular sieve tower, an air pump and a solenoid valve. The molecular sieve tower, filled with a nitrogen generation molecular sieve inside, is configured to convert received air into nitrogen and oxygen to generate nitrogen for the refrigerator. The air pump is configured to fill air into the molecular sieve tower. The solenoid valve is located at an oxygen discharge end of the molecular sieve tower.

The memory 58 is configured to store a computer program. The processor 56, when executing the computer program, implements any nitrogen generation control method in the above embodiments.

In the present embodiment, through the joint control of the nitrogen generation device and the cooling device, the nitrogen generation device can be adapted to the refrigerator environment. This addresses the problem that the lifespan of the nitrogen generation device is affected due to the fact that the related nitrogen generation control method is not suitable for the refrigerator environment for nitrogen generation of the refrigerator.

Those skilled in the art can understand that all or part of the processes in the above method embodiments may be implemented by a computer program to instruct related hardware, and the program may be stored in a non-volatile computer-readable storage medium. The computer program, when executed, may implement all or part of the steps of the embodiments of the methods described above. Any reference to a memory, a database, or other media used in the embodiments provided in the present disclosure may include at least one of a non-volatile memory and a volatile memory. The non-volatile memory may include read-only memory (ROM), magnetic tape, floppy disk, flash memory, optical memory, high-density embedded non-volatile memory, resistive random access memory (ReRAM), magnetic resistive random access memory (MRAM), ferroelectric random access memory (FRAM), phase change memory (PCM), graphene memory, and the like. The volatile memory may include a random access memory (RAM), an external cache memory, or the like. By way of illustration and not limitation, the RAM may be in various forms, such as a static random access memory (SRAM) or a dynamic random access memory (DRAM). The database in the embodiments provided in the present disclosure may include at least one of a relational database and a non-relational database. The non-relational database may include a blockchain-based distributed database and the like, and is not limited thereto. The processor in the embodiments provided in the present disclosure may be a general-purpose processor, a central processing unit, a graphics processing unit, a digital signal processor, a programmable logic device, a data processing logic based on quantum computing, or the like, and is not limited thereto.

The technical features in the above embodiments may be randomly combined. For concise description, not all possible combinations of the technical features in the embodiments are described. However, all the combinations of the technical features are to be considered as falling within the scope described in this specification provided that they do not conflict with each other.

The above embodiments only illustrate several implementations of the present disclosure, and the description thereof is specific and detailed, but cannot therefore be understood as limiting the protection scope of the present disclosure. It should be noted that those of ordinary skill in the art may further make variations and improvements without departing from the conception of the present disclosure, and these all fall within the protection scope of the present disclosure. Therefore, the protection scope of the present disclosure should be subject to the appended claims.

What is claimed is:

1. A nitrogen generation control method, applied to a nitrogen generation device of a refrigerator and comprising:
controlling a molecular sieve tower of the nitrogen generation device to perform exhaust when a refrigerator door is closed for a first preset duration and the refrigerator is in a cooling state, in response to a received nitrogen generation command; and
controlling the nitrogen generation device to generate nitrogen after the exhaust of the molecular sieve tower is completed.

2. The nitrogen generation control method of claim 1, wherein before controlling the molecular sieve tower of the nitrogen generation device to perform exhaust when the refrigerator door is closed for the first preset duration and the refrigerator is in the cooling state, in response to the received nitrogen generation command, the nitrogen generation control method further comprises:
monitoring an opening time and a closing time of the refrigerator door in real time in response to the received nitrogen generation command; and
detecting the cooling state of the refrigeration when the closing time of the refrigerator door reaches the first preset duration.

3. The nitrogen generation control method of claim 1, wherein controlling the molecular sieve tower of the nitrogen generation device to perform exhaust when the refrigerator door is closed for the first preset duration and the refrigerator is in the cooling state, in response to the received nitrogen generation command, further comprises:
controlling a solenoid valve at an oxygen discharge end of the molecular sieve tower of the nitrogen generation device to open when the refrigerator door is closed for the first preset duration and the refrigerator is in the cooling state, in response to the received nitrogen generation command; and
controlling the solenoid valve at the oxygen discharge end of the molecular sieve tower to close after the solenoid valve at the oxygen discharge end of the molecular sieve tower is opened for a second preset duration.

4. The nitrogen generation control method of claim 1, further comprising:
controlling the molecular sieve tower of the nitrogen generation device to perform exhaust when a closing time of the refrigerator door reaches a third preset duration, in response to a received initial nitrogen generation command; and
controlling the nitrogen generation device to generate nitrogen after the exhaust of the molecular sieve tower is completed.

5. The nitrogen generation control method of claim 1, wherein controlling the nitrogen generation device to generate nitrogen after the exhaust of the molecular sieve tower is completed further comprises:
after the exhaust of the molecular sieve tower is completed, when the refrigerator door is opened after the nitrogen generation device is controlled to generate nitrogen for a fourth duration, controlling the nitrogen generation device to stop generating nitrogen, wherein the fourth duration is less than a preset nitrogen generating duration.

6. The nitrogen generation control method of claim 5, wherein after the exhaust of the molecular sieve tower is completed, when the refrigerator door is opened after the nitrogen generation device is controlled to generate nitrogen for a fourth duration, controlling the nitrogen generation device to stop generating nitrogen, the nitrogen generation control method further comprises:
controlling the molecular sieve tower of the nitrogen generation device to perform exhaust when a closing time of the refrigerator door reaches the first preset duration and the refrigerator is in the cooling state; and
controlling the nitrogen generation device to generate nitrogen until a fifth preset duration is reached after the exhaust of the molecular sieve tower is completed, wherein the fifth preset duration is equal to a time difference between the preset nitrogen generating duration and the fourth duration.

7. The nitrogen generation control method of claim 1, wherein after controlling the nitrogen generation device to generate nitrogen after the exhaust of the molecular sieve tower is completed, the nitrogen generation control method further comprises:
generating nitrogen for the refrigerator periodically at a preset time interval when the refrigerator door remains closed.

8. The nitrogen generation control method of claim 1, wherein after controlling the nitrogen generation device to generate nitrogen after the exhaust of the molecular sieve tower is completed, the nitrogen generation control method further comprises:
controlling the molecular sieve tower of the nitrogen generation device to perform exhaust, when the refrigerator door is closed for the preset first duration after being opened and the refrigerator is in the cooling state; and
controlling the nitrogen generation device to generate nitrogen until a preset nitrogen generating duration is reached, after the exhaust of the molecular sieve tower is completed.

9. The nitrogen generation control method of claim 8, wherein controlling the molecular sieve tower of the nitrogen generation device to perform exhaust, when the refrigerator door is closed for the preset first duration after being opened and the refrigerator is in the cooling state, further comprises:
controlling the molecular sieve tower of the nitrogen generation device to perform exhaust, after the refrigerator door is closed for the first preset duration after being opened and the refrigerator maintains continues cooling for a sixth preset duration.

10. A nitrogen generation control system, applied to a nitrogen generation device of a refrigerator and comprising:
an exhaust module, configured to control a molecular sieve tower of the nitrogen generation device to perform exhaust when a refrigerator door is closed for a first preset duration and the refrigerator is in a cooling state, in response to a received nitrogen generation command; and
a nitrogen generation module, configured to control the nitrogen generation device to generate nitrogen after the exhaust of the molecular sieve tower is completed.

11. A refrigerator, comprising: a cooling device, a nitrogen generation device, and a processor and a memory connected to the cooling device and the nitrogen generation device;
wherein the cooling device is configured to cool the refrigerator when the refrigerator is in a cooling state;
the nitrogen generation device is configured to generate nitrogen for the refrigerator;
the nitrogen generation device at least comprises a molecular sieve tower, an air pump and a solenoid valve; the molecular sieve tower, filled with a nitrogen generation molecular sieve inside, is configured to convert received air into nitrogen and oxygen to generate nitrogen for the refrigerator;
the air pump is configured to fill air into the molecular sieve tower; the solenoid valve is located at an oxygen discharge end of the molecular sieve tower; and
the memory is configured to store a computer program, and the processor, when executing the computer program, implements steps of the nitrogen generation control method of claim 1.
